(19) United States
(12) Patent Application Publication
(10) Pub. No.: US 2015/0114191 A1
(43) Pub. Date: Apr. 30, 2015

(54) Method and Device for Manufacturing Filter Elements and Filter Element

(71) Applicant: MANN+HUMMEL GMBH, Ludwigsburg (DE)

(72) Inventor: Markus Roehrig, Landshut (DE)

(21) Appl. No.: 14/592,533

(22) Filed: Jan. 8, 2015

Related U.S. Application Data
(63) Continuation of application No. PCT/EP2013/064464, filed on Jul. 9, 2013.

(30) Foreign Application Priority Data
Jul. 9, 2012 (DE) 10 2012 013 470.3

(51) Int. Cl. B01D 46/00; B26D 7/27

(52) U.S. Cl. CPC B01D 46/0001; B26D 7/27
USPC 83/14; 83/404

(57) ABSTRACT

A filter medium is embossed to form embossments and the filter medium is then cut at least in some sections by a cutting device such as a water jet, a laser beam, an ultrasonic cutting device, or a cutter, by moving a point of impact of the cutting device relative to the filter medium to produce a cutting line. After cutting, the filter medium is folded. Alternatively, the filter medium is folded to folds and then at least some of the folds are pulled apart at least partially. In a region of the folds which have been pulled apart, the filter medium is cut at least in some sections thereof by the cutting device by moving a point of impact of the cutting device relative to the filter medium to produce a cutting line. After cutting, the folds are reset.

### CROSS-REFERENCE TO RELATED APPLICATIONS

This application is a bypass continuation application of international application No. PCT/EP2013/064464 having an international filing date of 9 Jul. 2013 and designating the United States, the international application claiming a priority date of 9 Jul. 2012, based on prior filed German patent application No. 10 2012 013 470.3, the entire contents of the aforesaid international application and the aforesaid German patent application being incorporated herein by reference.

### BACKGROUND OF THE INVENTION

The invention relates to a method and a device for manufacturing filter elements, in particular a method for cutting filter media in the process for producing a filter element, as well as a filter element.

A filter element is known from EP 1 144 083 B1 in which a support passes through a recess in the filter element. In particular for a housing which is suitable for receiving flat filter elements, a support can then be achieved between the opposing center points of the housing shells. In the event of component vibration these points would be those with the greatest vibration amplitude. Thus, in this way, a substantial reinforcement effect can be achieved by the provision of only one support. The recess is completely sealed relative to the support by the provision of an additional seal so that a reliable filter function without auxiliary air is ensured. According to a particularly favorable embodiment, the recess introduced into this filter element may be rectangular. It is oriented in such a way that two of the opposing edges of the rectangle, which are designated as transverse edges, extend parallel to the fold edges. In particular the edges can be formed by the fold edges themselves. Such a recess can be achieved most favorably in terms of manufacturing technology. It may be introduced, for example, by water jet cutting or laser beam cutting into the already folded filter medium.

A cutting device is known from EP 0 645 170 B by which the folded filter means provided with the glue beads is cut into individual filter elements. The cutting device cuts through the filter means transversely with respect to the transport device. The control signal for the cutting operation is emitted by means of a sensor which senses the actual end of the glue bead or the start of the glue bead or a measurement point disposed on the filter means and generates a control pulse with the aid of this signal. Filter elements produced by the method have the advantage that the external contour can be optimally adapted to the space available, wherein not only one but also both end faces of the filter element can be angled. Moreover, the possibility exists of also chamfering only parts of an end edge in order to adapt the contour of the filter element to the edges of the filter housing.

For the production of filter elements with recesses or for cutting filter elements, a more flexible, more favorable method is required which can be better integrated into the production process. In particular a method which can be carried out without building up stock, i.e. “online”, is advantageous. In the described method the filter elements are in each case manufactured, stored temporarily, and then a cutting operation takes place. In particular, a method is also advantageous which offers a better quality than, for example, a drill or a saw producing regularly particles which are undesirable in the further process and must be eliminated. Fuzz-free methods which can produce exact edges with fewer particles would be advantageous.

### SUMMARY OF THE INVENTION

A method for cutting filter media is proposed, wherein in one method step a filter medium is provided with embossments. Embossments may be, for example, transverse embossments which lie transversely with respect to a conveying direction of the filter medium and may serve for easier folding of the filter medium in a later method step. Embossments can be produced, for example, by embossing rollers. After embossing, the filter medium is cut at least in some sections with the aid of a water jet, laser beam or also an ultrasonic cutting device, or a cutter, such as is known from the field of fabric processing, wherein a blade is guided in the manner of a plotter over the filter medium.

In this case, cutting of the filter medium can produce holes in the filter medium, that is to say, in the form of closed curves. Cutting can take place in the conveying direction or transversely with respect thereto or at any angles. Cutting lines can also be introduced into the filter medium following any predetermined pattern. In this case, the filter medium may be available substantially as a flat sheet. The point of impact of the water jet, laser beam, the ultrasonic cutting device or the cutter on the filter medium moves during the cutting operation relative to the filter medium. The filter medium is only folded after the filter medium has been cut. As an alternative to a continuous cutting line, the cutting line can also be introduced in the form of a perforation. Removal of a region of the filter medium can take place before the setting of the folds after the cutting operation or on the set folds. For example, a folded bellows can be interrupted along a perforated cutting line or a cutout can be pressed out of a folded bellows. This removal from or on the folded bellows simplifies the process step of resetting the fold.

As an alternative method for cutting filter media, it is proposed that a filter medium is first of all folded. After folding, at least some of the folds are pulled apart again at least partially. Thus, the filter medium in which the folds are already formed, possibly also with an additional embossing step, is flattened again. In this case, the filter medium can again lie completely flat or can still have the fold formation in a more or less substantially flattened configuration. Advantageously, the entire filter medium is brought into this flatter form as it passes through a device for cutting the filter medium. However, in some sections it may remain in the folded form and may be flattened only in regions in which cutting is to take place. In the region of the folds which are at least partially pulled apart after embossing, the filter medium is cut at least in some sections with the aid of a water jet, laser beam or also an ultrasonic cutting device, or a cutter, such as is known from the field of textile processing, wherein a blade is guided in the manner of a plotter over the filter medium. In this case, cutting of the filter medium can produce holes in the filter medium, that is to say, cutting is done in the form of closed curves. Cutting can take place in the conveying direction or transversely with respect thereto or at any angle. Cutting lines can also be introduced into the filter medium following any predetermined pattern. The point of impact of the water jet, laser beam, the ultrasonic cutting device or the cutter on the filter medium moves relative to the filter medium. After the cutting operation the folds are reset.

As an alternative to a continuous cutting line, the cutting line can also be introduced in the form of a perforation. Removal of a region of the filter medium can take place before resetting the folds after the cutting operation or on the set folds. For example, a folded bellows can be interrupted along a perforated cutting line or a cutout can be pressed out of a folded bellows. This removal from or on the folded bellows simplifies the process step of resetting the fold.

In the alternative method, in which the folds are first set and then pulled apart again, the filter medium is also preferably embossed before the first setting of the fold. As also in the other alternative, due to embossing the setting of the folds can be simplified or facilitated, spacers can be introduced into the filter medium, and embossments can also serve as reference points for the control of the cutting operation, for example for relative positioning of the cutting point on the medium.

The proposed methods can be used for cutting a plurality of filter media. In particular these are paper and cellulose-based filter media, nonwovens and plastics-based filter media, for example, nonwovens or woven fabric in particular made of polyester, polyethylene, polyamide, polystyrene, but also cellulose mixed fiber media, different meltblown or spunbond media or also combinations of the foregoing, for example, cellulose as a support for further media layers. The choice of the cutting method by laser, water jet, ultrasound or cutter is also dependent upon the medium used. For example, water jet cutting may be less suitable for a cellulose medium, since this can possibly absorb water and can swell.

The proposed methods can also be used in each case simultaneously in a multi-track process, for example, in two or three tracks, two or three lasers can introduce perforations for cutting the folded bellows and can also introduce a cutout in each of the tracks.

In the case of a preferred variant, before the folding or resetting of the folds at least in some sections, adjacent to the cutting line introduced with the aid of the water jet, the laser beam, the ultrasonic cutting device or the cutter, a trace of sealant, in particular a trace of hot-melt adhesive, is applied to the filter medium. In this way, for example, a lateral sealing of the fold pockets can take place by means of the trace of sealant. A subsequent lateral sealing of the fold pockets, for example, by means of an adhered side strip, can be omitted.

In the method the filter medium is preferably conveyed and at least at times the water jet, laser beam, the ultrasonic cutting device or the cutter is likewise moved simultaneously with the conveying movement of the filter medium. In this way, filter elements can be efficiently cut from the filter media sheet or also produce cutouts in folded bellows.

A particularly efficient and flexible method is obtained in that the relative movement of the point of impact with respect to the filter medium is at least intermittently made up of the conveying movement of the filter medium and an additional movement, and wherein the additional movement at least intermittently comprises a movement component parallel to the conveying direction and/or a movement component perpendicular to the conveying direction. By virtue of a parallel component the conveying speed can also intermittently exceed the cutting speed since the point of impact can be moved at least intermittently in the conveying direction. By virtue of a perpendicular component, relatively freely selectable configurations of the cutting line can be produced.

In particular, such methods result in the case of a variant in which the point of impact of the water jet, laser beam, the ultrasonic cutting device or of the cutter is moved relative to the filter medium along a path which extends at least in some sections obliquely with respect to the conveying direction and/or is curved at least in some sections.

At least one hole or a cutout which is completely surrounded by the filter medium is preferably introduced into the filter medium, as already mentioned, by means of the water jet, laser beam, the ultrasonic cutting device or the cutter.

The methods for cutting filter media are advantageously integrated into a method for production of filter elements. As a result a method can be implemented which can be carried out without building up stock, i.e. “online”, since simple integration into the production of the folded bellows is possible and it is not necessary to further process a finished folded bellows.

During production of the filter element after the folding or the resetting of the folds on the folded filter medium, a seal is preferably applied which is provided for sealing contact on a filter housing. For a large number of uses, the application of a peripheral seal to the filter element is advantageous. Polyurethane foam in particular has proved successful as sealing material.

According to the invention, a device for cutting a filter medium is proposed which comprises a conveying device for a filter medium, an embossing device for introducing embossments into the filter medium; a water jet cutting device, laser beam cutting device, an ultrasonic cutting device or a cutter; as well as a fold setting device which is mounted in the conveying direction of the filter medium after the water jet cutting device, laser beam cutting device, ultrasonic cutting device or the cutter.

Alternatively, a device for cutting a filter medium is proposed which comprises a conveying device for a filter medium; a folding device for folding the filter medium; a device for pulling apart the folds; a water jet cutting device, laser beam cutting device, an ultrasonic cutting device or a cutter which is mounted in the conveying direction of the filter medium after the device for pulling apart the folds; as well as a fold setting device which is mounted in the conveying direction of the filter medium after the water jet cutting device, laser beam cutting device, ultrasonic cutting device or the cutter.

The control of the movement of the laser beam relative to the filter medium can preferably take place by mirrors. The deflection of the beam is preferably controlled by at least two mirrors which can be moved quickly, for example, by means of galvanometer drives. The third dimension, the depth focusing, can take place with the aid of a movable and controllable lens.

These devices for cutting a filter medium can advantageously be integrated into parts of a device for producing a filter element.

A filter element produced by the described production method is also encompassed by the invention.

A filter element comprising a folded bellows, wherein the external end edges of the folded bellows are cut by a laser beam or perforated by a laser beam and then cut, is also encompassed by the invention.

In a preferred embodiment, the filter elements are designed as flat air filters.

### BRIEF DESCRIPTION OF THE DRAWINGS

FIGS. 1a and 1 b show a filter element with a cutout.

FIG. 2 shows a device for producing a filter element in which the folded bellows is cut.

### DESCRIPTION OF PREFERRED EMBODIMENTS

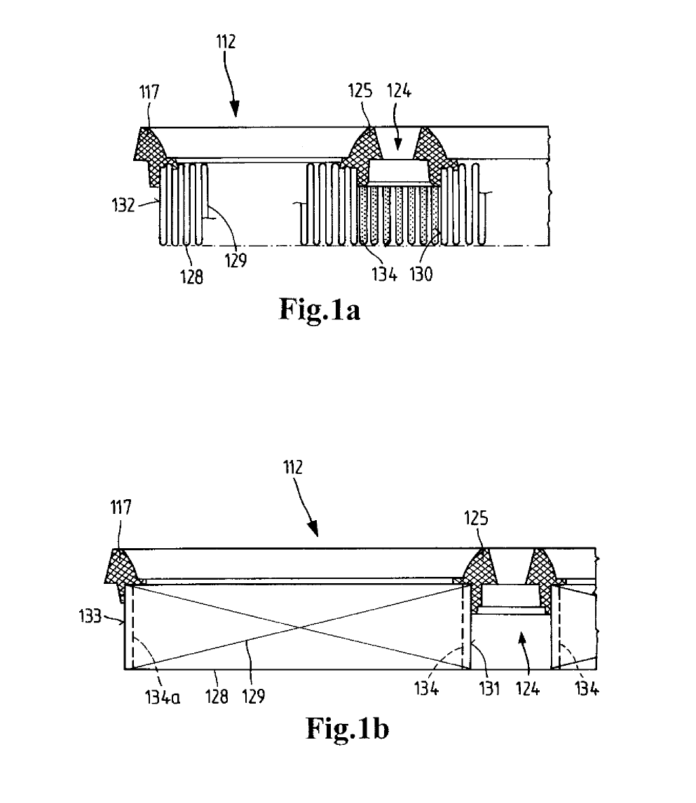

FIGS. 1a and 1b show as details a filter element 112, a so-called filter insert, in cross-section, in one case along fold edges 128 of the filter paper or filter medium 129 (FIG. 1 b) and in the other case transversely with respect thereto (FIG. 1a). In both cases, the cut extends centrally through the cutout 124, wherein it is clear that the cutout has a rectangular cross-section in the drawing plane. The cutout 124 has a circular cross-section perpendicular to the drawing plane. Along the fold edges 128, the cutout 124 has a transverse edge 130 and, at right angles thereto, it has an end edge 131. The additional seal 125 is injection molded on the upper edge forming the unfiltered media side of the filter element 112 and consists of PUR foam. It has the same profile as the edge seal 117 which is affixed on end edges 132 and lateral edges 133 and is likewise made of PUR foam.

For sealing of the end edges 131, the additional seal 125 can be extended down to the lower edge forming the clean side of the filter element 12. However, this is not illustrated in FIGS. 1a and 1b. The sealing of the respective adjacent filter folds or the lateral sealing of the fold pockets takes place here through a trace of sealant consisting of hot-melt adhesive, a so-called glue bead 134, applied on one side, as can be seen in FIG. 1a in the plan view of the end edge 131.

According to FIG. 1a, the glue bead 134 is located only in the region of the cutout 124. However, it is equally possible to lengthen this bead as far as the lateral edges 132 of the filter element 112 so that a stabilizing effect takes place in the transverse direction of the folds. The position of the glue beads 134 can also be seen from FIG. 1 b, where they are illustrated by broken lines. The end edges 133 of the filter element are likewise closed by glue beads 134a.

The cutout 124 has been introduced, wherein the filter medium 129 has first of all been provided with embossments. After embossing, the filter medium 129 was cut with the aid of a cutting device such as a water jet, laser beam, ultrasonic cutting device or a cutter at least in some sections, i.e. either completely cut through or perforated. The point of impact of the water jet, laser beam, the ultrasonic cutting device or the cutter on the filter medium is moved relative to the filter medium 129. After cutting, the filter medium 129 was folded. The glue bead 134 was applied before this folding operation. The folded filter medium 129 is optionally conveyed through a curing oven. The cutout was then pressed out of the completed folded bellows and then the seals 117 and 125 were applied.

Alternatively, the cutout 124 was introduced, the filter medium 129 having first been folded. After folding, at least some of the folds are pulled apart again at least partially. In the region of the folds which have been at least partially pulled apart again, the filter medium 129 was cut with the aid of a cutting device such as a water jet, laser beam, ultrasonic cutting device or a cutter at least in some sections. The point of impact of the water jet, laser beam, the ultrasonic cutting device or the cutter on the filter medium 129 moved relative to the filter medium 129. After cutting, the folds were reset, wherein the glue beads 134 were applied before this second folding operation. The folded filter medium 129 is optionally conveyed through a curing oven. The cutout was optionally pressed out of the completed folded bellows and then the seals 117 and 125 were applied.

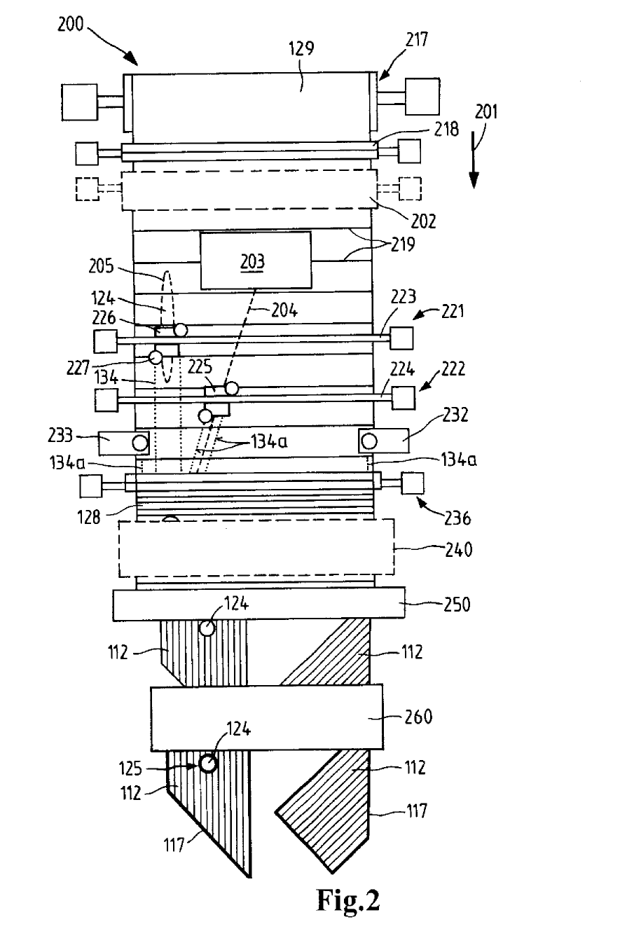

A device 200 for carrying out a method for producing a filter element 112 is illustrated in the schematic FIG. 2. First of all, the filter medium 129, for example the filter paper, is removed in the form of a filter medium sheet from a drum 217 and is conveyed through the device 200 along a conveying direction 201 which extends in particular perpendicular to the subsequently produced fold edges 128.

In a first processing step, the filter medium 129 is guided between a lower and an upper embossing roller 218. The lower embossing roller is not visible in the drawing. It is located immediately below the embossing roller 218. Folding edges 219 are embossed into the filter medium 129 by means of these embossing rollers. In addition bumps, reinforcing beads or spacers can also be embossed. Alternatively or additionally, the filter medium 129 can also be folded and stretched again in a pre-folding station 202.

The embossed or stretched filter medium 129 is delivered to a cutting device 203. The cutting device 203 comprises a laser cutting unit. The laser cutting unit comprises at least one deflecting device for the laser cutting beam, by means of which the point of impact of the laser beam on the filter medium 129 can be moved both parallel to the conveying direction 201 of the filter medium 129 (in FIG. 2 from top to bottom and vice versa) and also perpendicular to the conveying direction 201 of the filter medium 129 (in FIG. 2 from left to right and vice versa). The working range in which the laser cutting beam can be moved extends over the entire width of the filter medium sheet and moreover has a sufficient extent in the conveying direction 129. For example, two separate deflecting devices can be provided, by means of which in each case a laser cutting beam can be moved into a section of the working range.

The movement of the point of impact through the deflecting device can take place simultaneously with the conveying movement of the filter medium 129 so that the resulting relative movement of the point of impact relative to the filter medium 129 results from the conveying movement and the movement of the point of impact controlled by the deflecting device.

By means of the laser beam, the filter medium 129 can be cut through along a continuous cutting line. Alternatively a perforation can also be introduced and the complete cutting through action only takes place later. In the illustrated example, a closed cutting line 205 for forming the cutout 124 and a cutting line 204 extending obliquely with respect to the conveying device are introduced into the filter medium 129. In the case where the cutting line 205 is a continuous cutting line, the inner cutout can be removed downward on the laser cutting unit by means of its suction device.

The laser cutting unit is distinguished by particularly high dynamics in comparison with other cutting units with alternative cutting tools. Owing to these high dynamics, cutouts such as the illustrated cutout 124 can be introduced into the moved filter medium 129.

Two different filter elements 112 (one with and one without a cutout 124) are produced from the filter medium 129, which are disposed adjacent to each other transverse to the conveying direction 201. However, two similar filter elements 112 can also be produced adjacent to one another, for example. Depending upon the design of the filter elements 112, a reduction in waste is obtained.

Then, the filter medium 129 is provided with the necessary glue beads 134, 134a. For this purpose, first of all two glue application devices 221, 222 are provided. They each consist of a spindle 223, 224 on which support heads 225, 226 are located. Two glue application nozzles 227 are disposed on each of these support heads 225, 226. The application of the glue beads 134, 134a takes place while the filter medium 129 is being moved through below the glue application devices 221, 222 according to the arrow 201. In this case, the spindles 223, 224 are correspondingly rotated, so that the support heads 225, 226 carry out a transverse movement. The support head 226 serves for applying glue beads 134 on both sides of the cutout 124. The support head 225 serves for applying glue beads 134a along the cutting line 204. They both produce two glue beads 134, 134a in each case on the upwardly facing side of the filter medium 129 which is running through.

The support heads 225, 226 can also be moved by a belt or toothed belt. In particular when a toothed belt is used, the possibility exists of positioning the support heads with very high precision. Moreover, in the case of a belt or toothed belt drive, the adjustment speed is somewhat higher than in the case of a threaded spindle.

Of course the possibility also exists of producing filter elements 112 or carrying out the method solely with one glue application device. Depending upon the arrangement of the glue beads, however, it may however be necessary for this glue application device to be brought from the end position into the starting position at a very high speed in order to avoid gluing of a longer intermediate piece in case the glue application nozzles are not stopped. The gluing of two to three folds transversely with respect to the transport direction may in some circumstances be acceptable. If a plurality of folds are caused to be glued, this intermediate piece cannot be used, and unnecessary waste would be produced. Moreover two glue beads extending adjacent to one another—as is required in the example—cannot be applied by means of one individual glue bead applicator, at least above a certain spacing.

Two glue application devices 232, 233 are provided in addition to the glue application devices 221, 222. These produce glue beads 134a on the two end faces. After the application of all the glue beads 134, 134a, the zigzag folding of the filter material is carried out by means of a fold setter 236.

Optionally, one or more further glue application devices (not shown) can be provided after the fold setter 236. If need be, these apply a glue bead to the folded bellows which does not serve as a seal but as a supporting glue bead. Furthermore, the device 200 optionally also has a curing oven 240 through which the folded filter medium 129 is conveyed.

Then the folded filter medium 129 is cut in particular transversely with respect to the conveying direction 201 (along the fold edges 128) at a cutting station 250. Where appropriate, perforated contours are pressed out. This can take place automatically or manually. Individual folded bellows are produced which are then provided with seals 117, 125 in a further work station 260. For example, here they are placed individually in casting shells and, for example, PUR foam is added which is to be cured.

It will be understood that in a modified construction interim storage or at least transfer to the following station can take place between individual processing steps.

While specific embodiments of the invention have been shown and described in detail to illustrate the inventive principles, it will be understood that the invention may be embodied otherwise without departing from such principles.

What is claimed is:

1. A method for cutting a filter medium, comprising:
embossing a filter medium to form embossments;
after embossing, cutting the filter medium at least in some sections thereof by a cutting device, selected from the group consisting of a water jet, a laser beam, an ultrasonic cutting device, and a cutter, by moving a point of impact of the cutting device on the filter medium relative to the filter medium to produce a cutting line;
after cutting, folding the filter medium to form folds.

2. The method according to claim 1, further comprising,
before folding, applying a trace of sealant to the filter medium at least in some sections of the filter medium adjacent to the cutting line.

3. The method according to claim 2, wherein
the sealant is a hot-melt adhesive.

4. The method according to claim 1, wherein
the cutting line is a continuous cutting line.

5. The method according to claim 1, wherein
the filter medium is selected from the group consisting of paper, cellulose-based filter media, nonwovens, plastics-based filter media, woven fabric, cellulose mixed fiber media, meltblown media, spunbond media, and combinations thereof.

6. The method according to claim 5, wherein the filter medium is comprised of polyester, polyethylene, polyamide or polystyrene.

7. The method according to claim 1, further comprising
conveying the filter medium in a conveying direction and
moving the point of impact of the cutting device at least at times simultaneously with a conveying movement of the filter medium in the conveying direction,
wherein a relative movement of the point of impact relative to the filter medium is at least intermittently comprised of the conveying movement of the filter medium and an additional movement, the additional movement comprising at least intermittently a movement component parallel to the conveying direction; a movement component perpendicular to the conveying direction; or a movement parallel and perpendicular to the conveying direction.

8. The method according to claim 1, further comprising
conveying the filter medium in at least one conveying direction and
moving the point of impact of the cutting device relative to the filter medium along a path that extends at least in some sections obliquely to the conveying direction.

9. The method according to claim 1, further comprising
conveying the filter medium in at least one conveying direction and
moving the point of impact of the cutting device relative to the filter medium along a path that is curved at least in some sections.

10. The method according to claim 1, wherein,
in the step of cutting, a cutout is introduced into the filter medium and the cutout is completely surrounded by the filter medium.

11. A method for cutting a filter medium, comprising:
folding a filter medium to form folds;
after folding, pulling apart at least some of the folds at least partially;
in a region of the folds which have been pulled apart at least partially, cutting the filter medium at least in some sections thereof by a cutting device, selected from the group consisting of a water jet, a laser beam, an ultrasonic cutting device, and a cutter, by moving a point of impact of the cutting device on the filter medium relative to the filter medium to produce a cutting line;
after cutting, resetting the folds.

12. The method according to claim 11, further comprising,
before resetting of the folds, applying a trace of sealant to the filter medium at least in some sections of the filter medium adjacent to the cutting line.

13. The method according to claim 12, wherein
the sealant is a hot-melt adhesive.

14. The method according to claim 11, wherein
the cutting line is a continuous cutting line.

15. The method according to claim 11, wherein
the filter medium is selected from the group consisting of paper, cellulose-based filter media, nonwovens, plastics-based filter media, woven fabric, cellulose mixed fiber media, meltblown media, spunbond media, and combinations thereof.

16. The method according to claim 15, wherein
the filter medium is comprised of polyester, polyethylene, polyamide or polystyrene.

17. The method according to claim 11, further comprising
conveying the filter medium in a conveying direction and
moving the point of impact of the cutting device at least at times simultaneously with a conveying movement of the filter medium in the conveying direction,
wherein a relative movement of the point of impact relative to the filter medium is at least intermittently comprised of the conveying movement of the filter medium and an additional movement, the additional movement comprising at least intermittently a movement component parallel to the conveying direction; a movement component perpendicular to the conveying direction; or a movement parallel and perpendicular to the conveying direction.

18. The method according to claim 11, further comprising
conveying the filter medium in at least one conveying direction and
moving the point of impact of the cutting device relative to the filter medium along a path that extends at least in some sections obliquely to the conveying direction.

19. The method according to claim 11, further comprising
conveying the filter medium in at least one conveying direction and
moving the point of impact of the cutting device relative to the filter medium along a path that is curved at least in some sections.

20. The method according to claim 11, wherein
in the step of cutting a cutout, completely surrounded by the filter medium, is introduced into the filter medium.

21. A method for producing a filter element, comprising:
embossing a filter medium to form embossments;
after embossing, cutting the filter medium at least in some sections thereof by a cutting device, selected from the group consisting of a water jet, a laser beam, an ultrasonic cutting device, and a cutter, by moving a point of impact of the cutting device on the filter medium relative to the filter medium to produce a cutting line;
after cutting, folding the filter medium to form folds.

22. The method according to claim 21, further comprising,
after folding the filter medium, applying a seal on the folded filter medium, the seal adapted to seal relative to a filter housing.

23. The method according to claim 22, further comprising
forming the seal peripherally around the filter element.

24. The method according to claim 23, wherein the seal is comprised of polyurethane foam.

25. A method for producing a filter element, comprising:
folding a filter medium to form folds;
after folding, pulling apart at least some of the folds at least partially;
in a region of the folds which have been pulled apart at least partially, cutting the filter medium at least in some sections thereof by a cutting device, selected from the group consisting of a water jet, a laser beam, an ultrasonic cutting device, and a cutter, by moving a point of impact of the cutting device on the filter medium relative to the filter medium to produce a cutting line;
after cutting, resetting the folds;
applying a seal on the folded filter medium, the seal adapted to seal relative to a filter housing.

26. The method according to claim 25, further comprising
forming the seal peripherally around the filter element.

27. The method according to claim 26, wherein
the seal is comprised of polyurethane foam.

28. The method according to claim 25, further comprising:
forming a filter bellows by cutting external end edges by a laser beam.

29. A device for cutting a filter medium, the device comprising:
a conveying device adapted to convey a filter medium in a conveying direction;
an embossing device adapted to introduce embossments into the filter medium;
a cutting device selected from the group consisting of a water jet cutting device, a laser beam cutting device, an ultrasonic cutting device, and a cutter;
a fold setting device disposed in the conveying direction of the filter medium after the cutting device.

30. A device for cutting a filter medium, the device comprising:
a conveying device adapted to convey a filter medium in a conveying direction;
a folding device adapted to fold the filter medium to folds;
a device adapted to pull apart the folds;
a cutting device selected from the group consisting of a water jet cutting device, a laser beam cutting device, an ultrasonic cutting device, and a cutter, the cutting device mounted in the conveying direction after the device adapted to pull apart the folds;
a fold setting device mounted in the conveying direction after the cutting device.
